(19) United States
(12) Patent Application Publication
(10) Pub. No.: US 2012/0073339 A1
(43) Pub. Date: Mar. 29, 2012

(54) Emergency Garage door arm release

(76) Inventor: John A. Shagen, SR., Grasonville, MD (US)

(21) Appl. No.: 13/200,134

(22) Filed: Sep. 19, 2011

Related U.S. Application Data
(60) Provisional application No. 61/403,579, filed on Sep. 17, 2010.

(51) Int. Cl. E05B 49/02; E05B 65/08

(52) U.S. Cl. 70/278.1

(57) ABSTRACT

The invention provides a control mechanism for opening/unlocking the garage door. In this manner, the Emergency Garage Door Arm Release allows consumers to open their garage door from the outside. A transmitter is a control device installed on the outside of the garage and features a keypad on which the user punches in their security code and then activates the emergency release button. Once activated the Emergency Garage Door Arm Release sends a current to the solenoid which then releases the pin thus allowing the garage door to pop open. Once released, the consumer manually opens or raises the garage door the rest of the way.

### CLAIM OF PRIORITY

This patent application claims priority under 35 USC 119 (e) (1) from U.S. Provisional Patent Application Ser. No. 61/403,579, filed Sep. 17, 2010, of common inventorship herewith entitled, “Emergency Garage Door Arm Release.”

### FIELD OF THE INVENTION

The present invention pertains to the field of garage door safety devices, and more specifically to the field of garage door safety release devices.

### BACKGROUND OF THE INVENTION

The prior art has put forth several designs for garage door safety release devices. Among these are:

U.S. Pat. No. 4,167,833 to Richard C. Farina and Peter G. Sepesi describes an overhead garage door opener in which an actuating motor is secured to the door and is coupled to a capstan. A heavy cord, secured at one end to the garage wall above the door and at its other end near the back of the garage, is wound around the capstan. A motor control system such as a coded sound producing device and a time delay receiving circuit is disclosed, to start the motor to open or close the door.

U.S. Pat. No. 5,584,145 to Rudor Teich describes a wireless safety system for a garage door opener adapted for use at least in part with an independent energy source. The wireless safety system includes a control circuit for controlling movement of the garage door. An activation member provides an input to the control circuit to initiate motion of the garage door.

U.S. Pat. No. 6,070,361 to Robert S. Paterno describes a garage door operating system which includes a garage door, framing along which the garage door is positioned and travels between non-closed and closed positions, a signal generator which transmits a closed and or non-closed signal depending upon the position of the garage door, and finally includes an indicator which provides a suitable indicator signal upon receiving the signal.

None of these prior art references describe the present invention.

### SUMMARY OF THE INVENTION

It is an object of the present invention to provide a garage door safety release device.

It is a further object of the present invention to provide a transmitting and receiving system specifically designed for use with garage doors to provide an effective means of opening a closed garage door in the event of a power outage.

### BRIEF DESCRIPTION OF THE DRAWINGS

FIG. 1A is an elevational angled perspective view of the device of the present invention mounted on a closed garage door.

FIG. 1B is a close-up side angled perspective view of a portion of the device of the present invention showing the solenoid and manual release mechanism.

FIG. 2 is an elevational angled perspective view of the control panel for the device of the present invention.

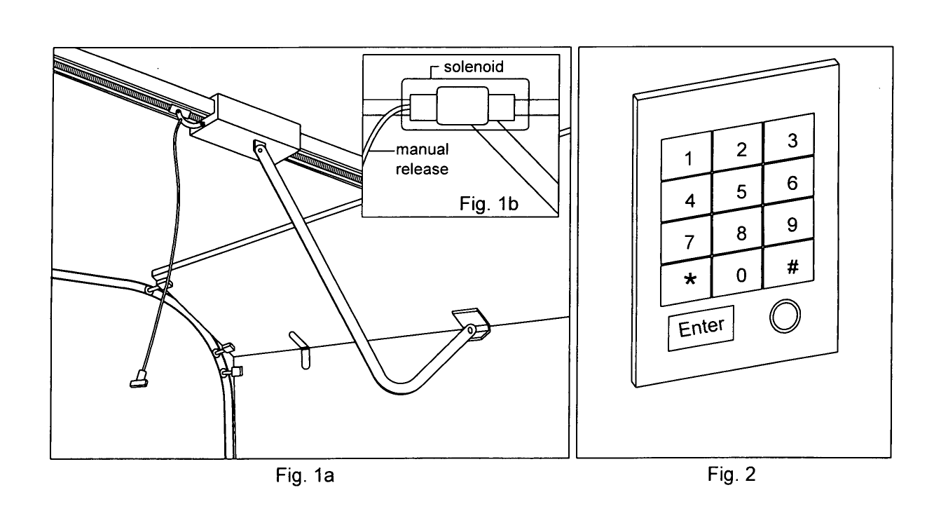

### DETAILED DESCRIPTION OF THE INVENTION

The present invention, hereinafter referred to as the Emergency Garage Door Arm Release, is a transmitting and receiving system specially designed for use with garage doors with the intent to provide an effective means of opening a closed garage door in the event of a power outage.

The Emergency Garage Door Arm Release is a handy control mechanism for opening/unlocking the garage door. In this manner, the Emergency Garage Door Arm Release allows consumers to open their garage door from the outside, eliminating the need to enter their home and then garage, simply to gain access to one's garage during a power outage.

The Emergency Garage Door Arm Release is an innovative product invention that proves invaluable to any home with a garage. Fostering security and confidence, this practical product allows users to keep their garage doors closed at all times, protecting their homes from intrusion, while also permitting easy access when one loses power or the electronic circuitry is compromised.

The transmitter is a control device installed on the outside of the garage and features a keypad on which the user punches in their security code and then activates the emergency release button. Once activated the Emergency Garage Door Arm Release sends a current to the solenoid which then releases the pin thus allowing the garage door to pop open. Once released, the consumer manually opens or raises the garage door the rest of the way. Enclosed within the plastic housing of the keypad, a battery source such as standard nine volt or AA alkaline is used to power the unit.

The Emergency Garage Door Arm Release provides consumers a simple and effective means of ensuring that their garage door is accessible at all times, even without power.

Affordably priced, the Emergency Garage Door Arm Release is well received by the millions of households that actively use their garage to store their vehicles as well as for a wide variety of other purposes.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. A garage door safety release device, for use with overhead garage door to provide an effective means of opening a closed garage door in the event of a power outage comprising: a transmitter and receiver, a security pad having a keypad, a solenoid, and a locking pin capable of being activated by the solenoid, a power sources, such as one or more batteries.

2. The device of claim 1 wherein the transmitter is a control device installed on the outside of the garage and comprises a keypad on which the user punches in their security code to activate the emergency release button wherein activation sends a current to the solenoid which then releases a pin thus allowing the garage door to be opened, and wherein when released, a user manually completely opens or raises the garage door.

3. The device of claim 2, wherein the security pad comprises a plastic housing and a battery source such as standard nine volt or AA alkaline batteries are housed within the plastic housing of the keypad.
